(19) United States
(12) Patent Application Publication
(10) Pub. No.: US 2004/0158643 A1
(43) Pub. Date: Aug. 12, 2004

(54) Network control method and equipment

(75) Inventors: Shinsuke Suzuki, Tama (JP); Yoshifumi Atarashi, Sagamihara (JP); Naoya Ikeda, Yokohama (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/758,114

(22) Filed: Jan. 16, 2004

(30) Foreign Application Priority Data
Feb. 10, 2003 (JP) 2003-031837

(51) Int. Cl. G06F 15/16

(52) U.S. Cl. 709/232

(57) ABSTRACT

By using combinations of a plurality of firewall techniques and making these techniques work together appropriately, problems presented with popular use of always-on Internet connections and end-to-end communications using IPv6 are resolved. This flexible manner of applying access control techniques grants favors to corporate network users, resulting from the popular use of always-on Internet connections and IPv6, e.g., the promotion of teleworking and virtual offices. A traffic control computing device which processes control requests from traffic control devices, provided in a network, coordinates the control actions of the individual traffic control devices appropriately.

### PRIORITY CLAIM

This application claims priority to under 35 USC 119 to Japanese patent application P-2003-031837 filed Feb. 10, 2003, the entire disclosure of which is hereby incorporated by reference herein.

### FIELD OF THE INVENTION

The present invention relates to techniques of communication control in the Internet and more particularly to firewall techniques.

### BACKGROUND OF THE INVENTION

When connecting an internal network such as a corporate network to the Internet, firewalls are generally interposed between the internal network and the Internet to prevent unauthorized access from the Internet to the internal network.

The firewalls operate on the assumption that any access from the outside to the internal network is unauthorized access. In the current situation that always-on Internet connections, end-to-end communications using IPv6, and the like are popularized, however, the above assumption is becoming incompatible with needs of internal network users, specifically in view of the following case. For example, when a business traveler or a telecommuter at home is attempting access to his or her corporate internal network, the firewalls reckon such access to be unauthorized access.

As one example of such firewalls, a packet filter technique which is applied in conjunction with an intrusion detection system (firewall) has been disclosed in U.S. Pat. No. 6,233,686. The outline of this invention is illustrated in FIG. 6A. In this invention, an authentication server is connected to a packet filter and the authentication server is also connected to a database in which rules of packet filtering specific to an individual user have been registered beforehand and stored. An external terminal user who attempts access to an entity in a local network of interest, first, must login to the authentication server. If the authentication server determines that the terminal user who requested access is a valid user, the authentication server refers to the database for a packet filtering rule associated with the user. The database is referred to with a key of the logged-in user name. The database is searched for a packet filtering rule associated with the logged-in user name and the packet filtering rule is returned to the authentication server. The authentication server transfers the filtering rule transferred from the database to the packet filter. The packet filter can change the packet filtering rule specific to the user who requested access if necessary.

A malicious user attempting unauthorized access may have success in login. Just in such cases, by providing a packet monitoring device in the network of interest, a packet having a pattern regarded as any of predefined patterns of unauthorized access can be detected. When the packet filter detects a packet that is regarded as the packet of unauthorized access, it issues a request to add a new filtering rule to the database, changes the relevant filtering rule, and automatically filters the invalid packet. Packets from a user who failed to login are discarded by the packet filter.

Academic Conference Papers “Distributed Firewalls” login, November 1999, pp. 39-47, Steven Bellovin and “Controlling High Bandwidth Aggregates in the Network”, Computer Communications Review Vol. 32 No.3, pp. 62-73, July 2002, Ratul Mahajan, Steve Bellovin, et. al disclosed techniques concerning distributed firewalls and aggregate congestion control. The outline of the techniques disclosed in the above papers is illustrated in FIG. 6B. For the model described in these papers, the packet filter or a similar device is not installed on the boundary between the internal network and the Internet. Instead, the terminals are provided with firewall functions (personal firewalls) such as the packet filter and a Web content filter. The personal firewalls are connected to a policy server and the settings and conditions of the personal firewalls are managed collectively by the policy server. Traffic states are detected by the terminals. Changes in traffic conditions are detected by the terminals. When a terminal detects anomalous traffic, the terminal sends a request for a filtering policy to the policy server to send a filtering policy. The policy server distributes a pre-registered filtering policy to the terminals. Having received the filtering policy, the terminal sends a request to execute filtering based on the policy to a router which is located upstream in the traffic flow. Through this procedure, when anomalous traffic occurs, the firewall function covering the whole network can be implemented.

Notably, the popularization of always-on Internet connections and end-to-end communications using IPv6 is coming to change the quality of communications via the Internet. Concretely, such change includes widespread use of peer to peer applications typified by instant messages; difficulty in mapping users to IP addresses by the diffusion of public wireless LAN services; increase of traffic for which realtime communications are required, typified by multicasting and Voice over IP; growing concern about Denial of Service (DoS) attacks; encrypted communications by the diffusion of IPsec; and expansion of the quantity of traffic to be monitored with increase in the number of terminals that are connected, using IP.

The prior art firewall techniques are not adaptable to the above change in communication quality. For example, with the technique disclosed in U.S. Pat. No. 6,233,686, filtering is impossible for encrypted packets. The reason hereof is that, because it is impossible to see the contents of the encrypted packets, the authentication server cannot refer to the database for a filtering rule. Also, the above technique is not resistive to the DoS attacks. The reason hereof is that, because traffic control only relies on authentication, once a user who sent a fraudulent packet has been authenticated, the user can get access to any entity in the local network even if it is a fraud.

Even with the invention of U.S. Pat. No. 6,233,686 combined with an intrusion detection system, it is practically impossible to do filtering of encrypted packets and to accommodate a variety of applications. When it turns out that a packet permitted to access the internal network is fraudulent, a device that detected unauthorized access attempts to add a filtering rule to block the access of the fraudulent packet sender by requesting a traffic control device (for example, a router) to do so. However, on the traffic control device such as the router, prior action of granting access permission to a sender of packets, once set, is effective. It is difficult to later block the access from the once authenticated packet sender. Therefore, even for a network system built by combining the invention of U.S. Pat. No. 6,233,686 with an intrusion detection system, it is impossible to do filtering of encrypted packets and to accommodate a variety of applications.

Next, in the distributed firewall architecture described in the above-mentioned academic conference papers, personal firewalls must be installed in not only terminals in the corporate network, but also all external terminals. Therefore, the network scale becomes large and, with the increase of quantity of traffic to be filtered, the cost of building the system increases. The policy server is a device which distributes a predetermined filtering policy to all terminals in one way. Therefore, if a plurality of firewall techniques perform different types of control that conflict with each other or if different packet filtering techniques which are incompatible with each other are used, some policy server cannot perform traffic control taking network compatibility into account.

Furthermore, all the foregoing techniques in question involve a problem that loads on the control device increase due to increase in the number of filtering rules as the quantity of traffic to be filtered increases.

As discussed above, there exist no firewall techniques that solve the problems presented in communications via the. Internet concurrently. Even with a plurality of prior art firewall techniques which are simply combined, theses problems cannot be solved concurrently. The reason hereof is that it is impossible to address the problems in the circumstances where a plurality of firewall techniques perform different types of control that conflict with each other and different packet filtering techniques are incompatible with each other.

Explaining the foregoing problems through generalization, when a plurality of devices issue traffic control requests and traffic control is executed, a requesting device must do not only transmitting its own traffic control request to the traffic control device, but also blocking the traffic control request from another requesting device to the same traffic control device.

### SUMMARY OF THE INVENTION

The present invention provides a scheme for solving the above problems by linking and aggregating data concerning a plurality of firewall techniques at one point and automatically managing such data.

Network control equipment of the present invention comprises traffic control request detecting devices which provided data by which it is determined whether traffic is passed or rejected, traffic control devices which actually execute network traffic control, and a traffic control computing device which processes control requests from the traffic control devices.

When the traffic control computing device receives a traffic control request from a traffic control request detecting device, it stores the received traffic control request into a storage device. Then, the traffic control computing device computes how a traffic control device connected to it implements traffic control, based on control information stored in it and the functions of the traffic control devices and current settings of control.

At the same time, the traffic control computing device acquires information about traffic control (traffic control information) from the traffic control devices under its management. The thus acquired traffic control information is stored into the storage device. When booted, the traffic control computing device acquires and learns the initial settings set on the traffic control devices.

If a plurality of traffic control devices exist in a network, control requests from the traffic control devices may conflict with each other. In that event, the traffic control computing device coordinates the control requests issued from the network control devices so that the whole network control equipment will operate consistently without being affected by the conflict. Also, the traffic control computing device of the present invention overcomes the incompatibility problem of different traffic control methods by aggregative processing of traffic control requests issued from a plurality of devices. Thereby, affinity between different traffic control techniques is provided.

### BRIEF DESCRIPTION OF THE DRAWINGS

FIG. 1 shows a simplified structural diagram of a commonly used packet filter;

FIG. 2A shows a hardware configuration diagram of a traffic control computing device 230 of Embodiment 1 with other components of the traffic control system FIG. 2B is a functional block diagram of the traffic control computing device configuration of Embodiment 1, where traffic control request detecting devices 210 and 215 and traffic control devices 220 and 225 are also shown.

FIG. 3 is a flowchart for explaining a procedure in which the traffic control computing device acquires control information from traffic control devices in the present invention;

FIG. 4 is a flowchart for explaining a procedure in which the traffic control computing device controls the traffic control devices, according to a control request from a traffic control request detecting device;

FIG. 5 shows an example of a network configuration built, according to the present invention; and

FIGS. 6A and 6B are schematic diagrams for explaining prior art access control methods.

### DETAILED DESCRIPTION OF THE PREFERRED EMBODIMENTS

(Embodiment 1)

In the following, preferred embodiments of the present invention will be described concretely.

As concrete examples of traffic control request detecting devices in the embodiments that will be described hereinafter, for example, intrusion detection systems which detect abnormal traffic, user authentication servers for user authentication firewalls, and policy servers for distributed firewalls are applicable. As concrete examples of traffic control devices, for example, packet filters, traffic shapers, application gateways, and personal firewalls are applicable. It is preferable that the traffic control computing device communicates with the traffic control request detecting devices and the traffic control devices in a reliably communicable state, using a network for management, encrypted communication, and the like. The network is usually owned by a telecommunications carrier or a corporate network operator. The invention may be embodied in a traffic control system, and in the embodiments set forth herein, therefore, the traffic control system may be owned by the carrier or the corporate network operator, or alternatively, may be owned by a service provider that provides any service on the network.

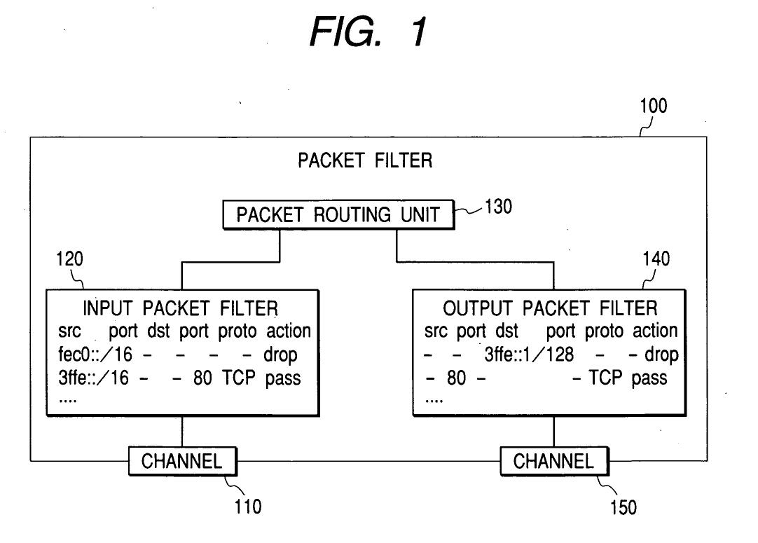

FIG. 1 is a diagram for explaining the operation of a commonly used packet filter device. When the packet filter 100 receives a packet from a channel 110, an input packet filter 120 matches the input packet against all input packet filtering rules it has and determines whether the packet should be passed. Concretely, the IP address, port number, and protocol type specified in the packet are matched against all the packet filtering rules and, according to the matched rule, it is determined whether the packet should be passed. If it is determined that the packet should not be passed, the input packet filter 120 discards the input packet. If it is determined that the packet should be passed, the packet is output to an appropriate output channel interface 150 which is determined by routing executed by a packet routing unit 130. Before outputting to the output channel interface 150, an output packet filter 140 determines whether the packet should be output. This determination is made by a criterion that is applied in the same manner as for input packets. If it is determined that the packet should be output, the packet is output to the output channel interface 150. By specifying input packet filtering rules and output filtering rules appropriately, the packet filter can forward only proper packets from the Internet to a corporate network. However, it is difficult to set the filtering rules appropriately for connection requests via the Internet and abnormal access tendency. It is difficult to apply this device to encrypted communication in which any entity other than the sender and recipient cannot see the packet contents.

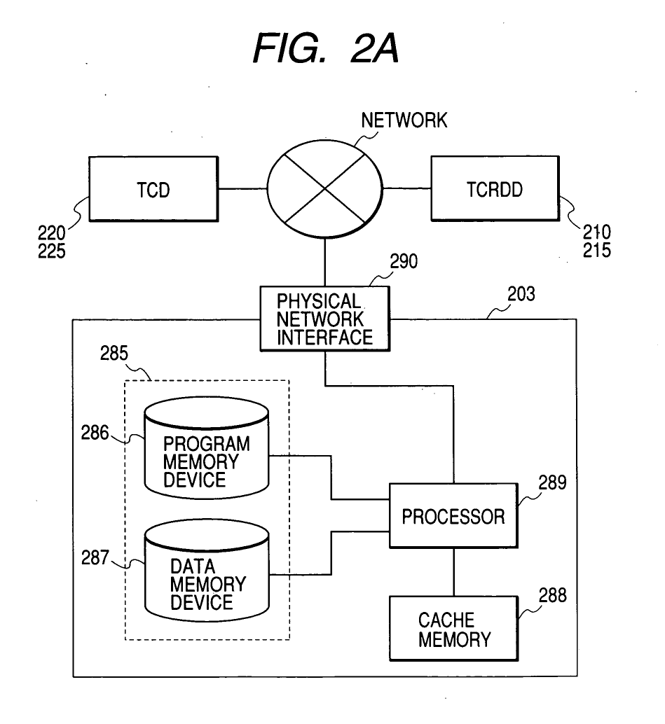

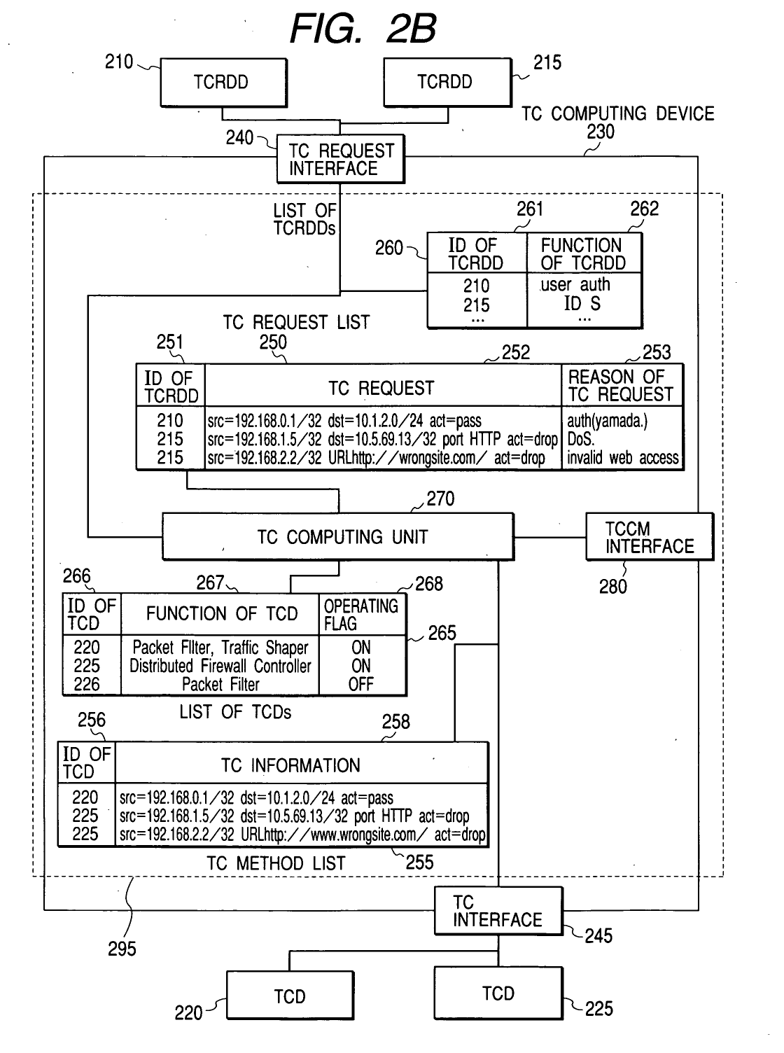

FIG. 2A shows a hardware configuration diagram of a traffic control computing device 230 of Embodiment 1 with other components of the traffic control system. The traffic control device 220, a traffic control request detecting device 210, and the traffic control computing device 230 are connected via the network. The traffic control computing device 230 includes storage 285 such as a semiconductor memory and a hard disk, a processor 289 which may be a processor or a microcomputer, and a physical interface for network connection 290. In FIG. 2A, a cache memory for temporarily storing communications data received through the physical interface for network connection 290 is also shown; however, the cache memory may be dispensed with. The storage 285 consists of a program storage device 286 for storing programs which are shown in FIG.2B and a data storage device 287 for storing data. While the storage device for storing programs and the storage device for storing data are shown as physically different entities in FIG. 2A, the space on the same storage device may be divided into the space for programs and the space for data. The processor is used to execute the programs. The physical interface for network connection 290 is used for the traffic control computing device 230 to communicate with the traffic control device 220 and the traffic control request detecting device 210. Concretely, communications data such as IP packets and ATM cells are input and output through the physical interface for network connection 290.

FIG. 2B is a functional block diagram of the traffic control computing device configuration of Embodiment 1, where traffic control request detecting devices 210 and 215 and traffic control devices 220 and 225 are also shown. The traffic control computing device 230 of Embodiment 1 includes a traffic control request interface 240 to transmit and receive information between a traffic control request detecting device and a specific functional block, a traffic control interface 245 to transmit and receive information between a traffic control device and a specific functional block, a traffic control computing management interface 280 through which a network administrator intervenes in traffic control computation, and an arbitration unit 295 which performs arbitration of diverse traffic control requests transmitted from external communication devices. The arbitration unit 295 is represented by an area surrounded by a dotted line in the figure. More specifically, the arbitration unit 295 includes a traffic control request list 250 which contains traffic control requests from the traffic control request detecting devices 210 and 215, a list of traffic control methods 255 which are computed, based on the contents of the traffic control request list 250, a list of traffic control request detecting devices 260, a list of traffic control devices 265, and the functional blocks of a traffic control computing unit 270 which exerts overall control of the traffic control computing device. To the traffic control computing unit 270, the traffic control computing management interface 280 is connected. All the interfaces (240, 245, and 280) and the traffic control computing unit 270 are realized by the programs stored in the program storage device shown in FIG. 2A. The programs are read and executed by the processor 289 and their execution involves communication with the outside via a physical network for network connection 295, when necessary.

The list of traffic control request detecting devices 260 and the list of traffic control devices 265 are realized in data tables which are stored in the data storage device 287. The list of traffic control request detecting devices 260 has entries of identification information for all traffic control request detecting devices (210 and 215 in this embodiment) connected to the traffic control computing device 230. The list of traffic control devices 265 has entries of identification information for all traffic control devices connected to the traffic control computing device 230. As the identification information, for example, the IP addresses, host names, and the like of the traffic control request detecting devices 210 and 215 and the traffic control devices 220 and 225 may be used.

The list of traffic control request detecting devices 260 and the list of traffic control devices 265 give information about what processing can actually be performed on each of the above devices. Meanwhile, the traffic control request list 250 gives information about what processing is now requested by each of the traffic control request detecting devices. The traffic control method list 255 gives information about what processing is now executed by each of the traffic control devices. The list of traffic control request detecting devices 260 and the list of traffic control devices 265 are information essential for preventing fraudulent input. The traffic control request list 250 and the traffic control method list 255 are information essential for device status management.

All lists (250, 255, 260, and 265) within the traffic control computing device 230 are stored in the data storage device shown in FIG. 2A. When storing the lists, all lists may be stored into one storage means or separate storage means may be provided for each list.

The traffic control computing device 230 exchanges information with the traffic control request detecting devices 210 and 215 connected to it on the network through the traffic control request interface 240. To do this, it is desirable that security of communication is ensured between the traffic control computing device 230 and the traffic control request detecting devices 210 and 215. It is particularly preferable to use the network for management and encrypted communication for the communication between the above detecting devices 210 and 215 and the above computing device 230.

Similarly, the traffic control computing device 230 is connected to the traffic control devices 220 and 225. The traffic control computing device 230 exchanges information with the traffic control devices 220 and 225 connected to it on the network through the traffic control interface 245.

The traffic control request detecting device 210, traffic control request detecting device 215, and the traffic control devices 220 and 225 are usually connected via communication lines, a network, or the like, which is, however, not shown.

In the following, how the functional blocks within the traffic control computing device shown in FIG. 2B operate and how the whole network system including the traffic control computing device operates will be explained.

The traffic control request detecting devices 210 and 215 monitor the conditions of the channels connected thereto and determine what traffic control is necessary. After determining a necessary traffic control, the traffic control request detecting devices 210 and 215 notify the traffic control computing device 230 of the necessary traffic control, using a form of control packets or control frames (ATM frames, Ether frames, etc.).

The notified control information is processed through the traffic control request interface 240. The traffic control request interface 240 parses the received control information and extracts information describing the ID of the sender of the control information, the details of the traffic control requested, and the reason for requesting that control. Concretely, the control information is received by the physical interface for network connection 290 and transferred to the processor 289. The processor 289 retrieves a program corresponding to the traffic control request interface 240 from the program storage device 286 and executes the program to process the received control information. Each information extracted is temporarily stored into the cache memory shown in FIG. 2A or registers within the processor.

Upon receiving a traffic control request, the traffic control computing unit 270 updates the traffic control request list 250. The traffic control request list 250 comprises a traffic control request detecting device ID field 251 to store the ID of a traffic control request detecting device connected to the traffic control computing device, a traffic control request field 252 to store the details of a control request extracted from received traffic control information, and a traffic control request reason field 253 to store the reason for requesting the traffic control. IDs are assigned to the traffic control request detecting devices connected to the traffic control computing device 230. When the list 250 is updated, the detecting device ID that sent the request and actually requested control details are stored into the list. The reason why the traffic control is necessary is also written into the list 250. When the above update operation is practically performed, the traffic control request list 250 is first retrieved from the data storage device 287 and a program for updating the traffic control request list is retrieved from the program storage device 286 by the processor 289. Then, the processor 289 refers to the information extracted from the request and stored in the cache memory and performs the list update operation, according to the retrieved program.

When the list 250 is updated, the list of traffic control request detecting devices 260 is referred to. The list of traffic control request detecting devices 260 is also stored in the data storage device 287 within the storage 280. The list of traffic control request detecting devices 260 comprises a traffic control request detecting device ID field in which the ID of a traffic control request detecting device connected to the traffic control computing device was stored and a traffic control request detecting device function field in which a traffic control request command detectable by the traffic control request detecting device connected was stored. When updating the list 250, the traffic control computing unit 270 refers to the list 260 and, if the ID of the sender of the notified traffic control request is not listed in the list 260, judges the control request as a fraud and rejects the request. The reference operation to the list 260 is also practically performed by the processor 289.

Then, the traffic control computing unit 270 computes a traffic control algorithm which is necessary for one of the traffic control devices 220 and 225 connected to the traffic control computing device, based on the traffic control request which has just been stored into the list 250. Alternatively, it may also be preferable to prepare a plurality of control algorithms in accordance with the number of connected traffic control devices and select an appropriate algorithm, according to the traffic control requested from one of the traffic control request detecting devices 210 and 215. In this case, an algorithm table in which the algorithms were stored is included within the data storage device 287. The algorithm table comprises an identification information field (for example, ID) to identify a traffic control request device connected to the traffic control computing device, a traffic control designation field to designate a requested traffic control, an algorithm filed in which an algorithm for the traffic control designation was stored, and other fields. Separate fields are provided for traffic control designation and algorithm, because one traffic control request detecting device may detect a plurality of types of traffic control requests. If the traffic control request detecting devices are capable of detecting a single type of traffic control request, the traffic control designation field may be dispensed with. The above operation of computing or selecting an algorithm is performed by the processor 289, according to the appropriate program retrieved from the program storage device 286.

A computed or selected control algorithm is transmitted to one of the traffic control devices 220 and 225 through the traffic control interface 280. The traffic control device 220 or 225 executes traffic control in accordance with the control algorithm transmitted thereto. Concretely, the computed or selected algorithm is, first, temporarily stored into the cache memory. Then, a program corresponding to processing to be performed by the traffic control interface 280 is retrieved from the program storage device 286 and executed by the processor 289. The processing program for the traffic control interface 280 generates control information (in policy control packets, control frames, etc.) by referring to the algorithm stored in the cache memory, the list of traffic control devices 265, and the traffic control method list 255. The control information must include its destination address, that is, the address of the traffic control device to which the algorithm should be sent. The address of the traffic control device is obtained from ID information within the list of traffic control devices 265. If, for example, IP address data is used as the ID information, the ID of the particular traffic control device in the list could be specified as is for the address of the traffic control device. The generated control information is transmitted to the target traffic control device through the physical interface for network connection 290.

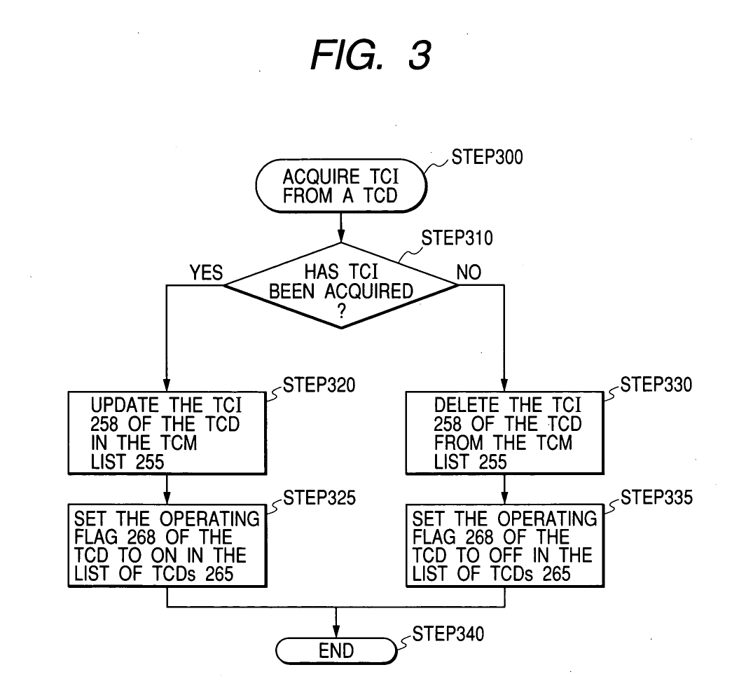

A flowchart of FIG. 3 explains a procedure in which the traffic control computing device 230 acquires information objects from the traffic control devices. The traffic control computing device 230 acquires traffic control details which are now executed by each of the traffic control devices listed in the list of traffic control devices 265. Concretely, the traffic control computing device acquires configuration definition per traffic control device via the traffic control interface 245 (step 300). If the control details to be executed by a traffic control device have been acquired, the control details are stored into the entry of the traffic control device in the traffic control method list 255 (step 320). At the same time, the operating flag 268 of the traffic control device entry in the list of traffic control devices 265 is set ON (step 235). Otherwise, if the control details to be executed by a traffic control device cannot be acquired, the traffic control method entry of the traffic control device is deleted from the traffic control method list 255 (step 330) and the operating flag 268 of the traffic control device entry in the list of traffic control devices 265 is set OFF (step 335).

A flowchart of FIG. 4 explains a procedure in which the traffic control computing device 230 processes a request which may or may not be issued from one of the devices (with their IDs 210 and 215) listed in the list of traffic control request detecting devices. When the traffic control request interface 240 receives a traffic control request, it is checked whether the traffic control request detecting device 260 that issued the request is included in the list of traffic control request detecting devices 260 (step 410). If the device is not included in the list, the traffic control request is judged as a fraud and rejected (step 415). If the device is included in the list, the traffic control request is judged to be valid. It is checked whether any content of the entries of the control requests previously issued from the traffic control request detecting devices conflicts with the newly input control request (step 420). If such an entry exists, it is determined whether the entry is the request from the same traffic control request detecting device (step 425).

If the entry is the request from the same traffic control request detecting device, the entry is overwritten with the new traffic control request (step 430). If the entry is the request from another device, through the management interface, the traffic control computing device notifies a network administrator (for example, a person or artificial intelligence system) who can make a decision on a higher level of the conflicting requests (step 432). The network administrator notified of the conflicting requests decides to reject which traffic control request and directs that either of the requests should be rejected via the traffic control computing management interface 280 (step 435). As the result of the decision (step 440), if the new traffic control request has been rejected, the traffic control computing device 230 notifies the traffic control request detecting device that issued the control request that the request was rejected through the traffic control request interface 240 (step 445). The traffic control request detecting device may ignore the notification of the rejection or may use the notification to cancel the event such as user authentication, based on which the control request was generated.

If the old traffic control request has been rejected in the step 440, the traffic control computing device 230 operates as if the traffic control request detecting device that is the sender of the old request cancelled the request by direct request input from it (step 430). If there is no entry whose content conflicts with the new traffic control request in step 420, no specific processing is performed. After the step 420 and following steps described above are finished, unless the new control request has been rejected, the new traffic control request is added to the traffic control request list 250 (step 450).

After a new traffic control request list is generated in step 450, the traffic control computing unit 270 computes how the listed traffic control requests are completed by using the traffic control devices whose operating flags 268 are ON, included in the list of traffic control devices 265 (step 460).

When executing this computation, the traffic control computing unit optimizes the traffic control methods to provide the maximum transfer capability of the network, taking account of the traffic control device function 267 entries in the list of traffic control devices 265 and the current traffic control method entries in the traffic control method list 255. Possible optimization methods include load balancing across the traffic control device, function differentiation across the traffic control devices, minimizing the number of traffic control rules, and combinations thereof. For example, to perform the load balancing across the traffic control devices, traffic control tasks should be assigned to the traffic control devices which effect traffic control details so that an equal number of traffic control information 258 objects will be assigned to each traffic control device in the traffic control method list 255. To perform function differentiation across the traffic control devices, traffic control tasks should be assigned to the traffic control devices which perform the tasks, according to the type of traffic described in traffic control information; for example, assign filtering of TCP/UDP datagrams to the traffic control device 220 and assign filtering of URL datagrams to the traffic control devices 25. Which optimization method should be taken is decided by the network administrator and definition thereof should be supplied beforehand to the traffic control computing unit 270 through the traffic control computing management interface 280.

After computing the implementation methods of traffic control in step 460, the traffic control computing device 230 compares the traffic control method list obtained by the computation with the past traffic control method list 255 and extracts differences (step 470). The traffic control computing device requests the traffic control devices to additionally execute the control tasks of the differences relevant to their functions through the traffic control interface 245 (step 480). Finally, the traffic control method list 255 is overwritten with the new traffic control method list (step 490). Because the traffic control devices retain the control algorithms previously sent to them, only the control algorithms of the difference data should newly be transmitted to them.

(Embodiment 2)

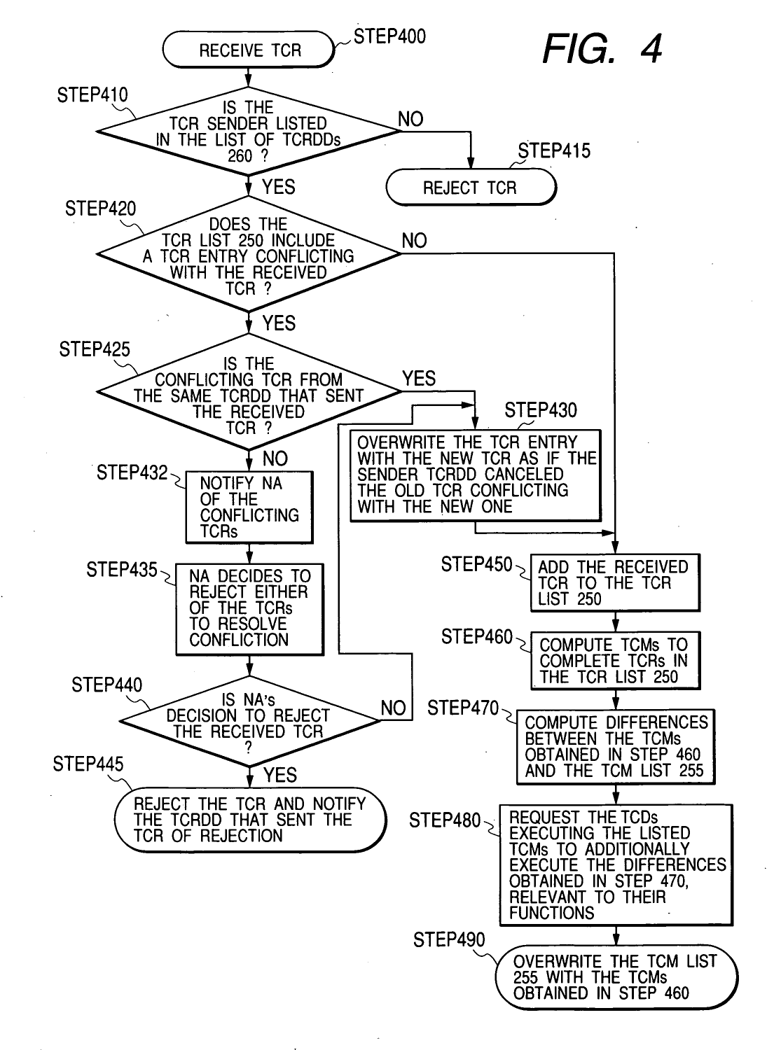

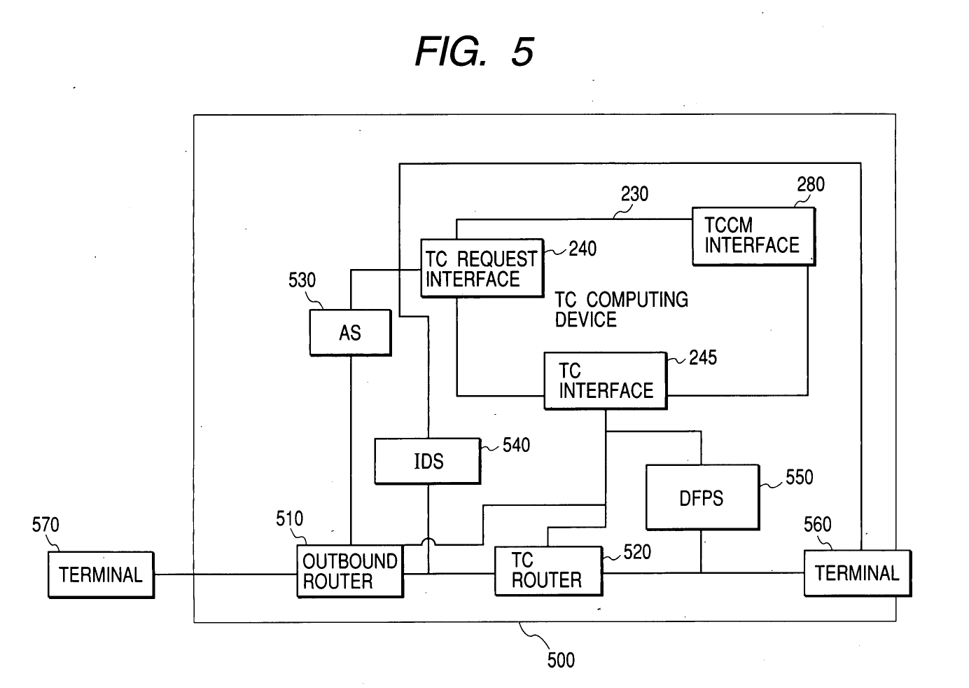

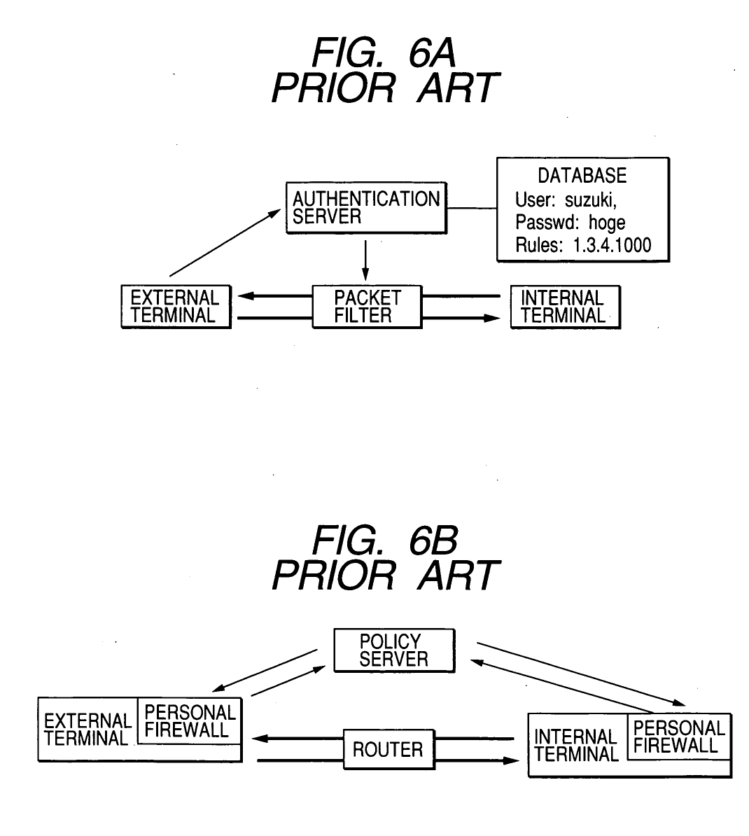

FIG. 5 shows an example of a network configuration built, according to the present invention. This corporate network 500 includes an outbound router 510, a traffic control router 520, an authentication server 530, an intrusion detection system 540, a distributed firewall policy server 550, and a terminal 560 at the entry of the distributed firewall. The traffic control computing device 230 connects to the authentication server 530, intrusion detection system 540, and the terminal 560 at the entry of the distributed firewall via the traffic control request interface 240 and connects to the outbound router 510, traffic control router 520, and distributed firewall policy server 550 via the traffic control interface 245.

When the user of a terminal 570 which is positioned outside the corporate network is getting access to the terminal 560 in the corporate network, first, the user must login to the authentication server 530. When the login is allowed, the authentication server grants the user the right of communication appropriate for the user and sends a request to permit the communication to the traffic control computing device 230 via the traffic control request interface 240. The traffic control computing device 230 processes the control request, according to the flowchart of FIG. 4 and directs the traffic control router to permit the communication between the terminal 560 and the terminal 570 and also directs the distributed firewall policy server 550 to permit the communication between the terminal 560 and the terminal 570.

In the following, when the network system 550 is put under a DoS attach using the terminal 570, how the traffic control computing device operates will be described. When the intrusion detection system 540 detects the DoS attack from the terminal 570, the intrusion detection system 540 sends a request to stop the communication to the traffic control computing device 23 via the traffic control request interface 240. As the traffic control computing device 230 processes the control request, according to the flowchart of FIG. 4, the computing device detects that the request from the authentication server 530 conflicts with the request from the intrusion detection system 540. In this case, the traffic control computing device 230 warns the network administrator by suitable means such as e-mail through the traffic control computing management interface 280. The network administrator decides what action should be taken in response to the warning and directs the traffic control computing device 230 to take the action via the traffic control computing management interface 280.

For example, if the administrator decides to make the traffic control router 520 narrow the bandwidth of the traffic in question, thereby coping with the attach, the administration inputs an instruction to narrow the traffic bandwidth via the traffic control computing management interface 280 to the traffic control computing device. Then, the traffic control router 520 will operate, according to the instruction. For example, when the personal firewall in the terminal 560 detects that the terminal 570 user attempts to destroy the system running on the terminal 560, the personal firewall notifies the traffic control computing device 230 of this attack. In this case, usually, the traffic control computing device 23 need not apply new traffic control particularly. If the traffic control request list 250 comes to include too great quantities of same requests, it is desirable to block the communication. In that event, as the traffic control computing device 230 executes the procedure according to the flowchart of FIG. 4, the computing device computes a control method by which to block the communication, according to the above notification from the firewall. In consequence, the computing device sends an instruction to the authentication server 530 to cancel the login request from the terminal 570 and also sends instructions to the traffic control router 520 to remove the packet filtering rule to pass the packets to be communicated between the terminal 570 and the terminal 560 and stop the bandwidth control which is no longer needed.

By introducing the traffic control computing device of the present invention, traffic control appropriate for unauthorized access and valid access requests can be realized flexibly by combinations of existing traffic control devices. Thereby, convenience in using a corporate network from the outside can be enhanced in safety and corporate network users can benefit from the popular use of always-on Internet connections and IPv6, e.g., the promotion of teleworking and the evolution of virtual offices.

The above description is in no way limiting in regard to the inventor's contemplated equivalents and variations contemplated and considered disclosed herein by the inventor's.

What is claimed is:

1. A traffic control computing device comprising:
a traffic control interface to connect to traffic control devices which control traffic in a network;
a traffic control request interface to connect to traffic control request detecting devices which determine whether a traffic control must be executed by said traffic control devices;
a first storage device in which information about traffic control received via the traffic control request interface is stored;
a traffic control computing unit connected to said traffic control interface, and connected to said traffic control request interface, and connected to said first storage device,
wherein said traffic control computing unit computes traffic control algorithms based on traffic control requests stored in the first storage device and sends the traffic control algorithms to said traffic control interface.

2. The traffic control computing device according to claim 1, further comprising:
an information unit for acquiring information objects about traffic control details per a traffic control device associated with IDs of the traffic control devices which are now executed separately by said traffic control devices; and
second storage device in which said acquired information objects about traffic control details per traffic control device associated with the IDs of the traffic control devices are stored.

3. The traffic control computing device according to claim 1, wherein IDs of said traffic control request detecting devices are stored in said first storage device.

4. The traffic control computing device according to claim 1, wherein said traffic control computing unit compares the sender of a traffic control request received through said traffic control request interface for a match with any of traffic control information objects stored in said first storage device and rejects said traffic control request if said sender of the received request is not stored in said first storage device.

5. The traffic control computing device according to claim 4, further comprising a traffic control computing unit as a management interface which functions as a contact point for communicating with a network administrator and is structured so that said traffic control computing unit checks whether a traffic control request that conflicts with said traffic control request received is included in said first storage device and, if a conflicting traffic control request is included, compares the sender of the conflicting traffic control request with the sender of said traffic control request received, and, if both the senders are different, sends a notification of the conflicting requests to said traffic control computing management interface.

6. The traffic control computing device according to claim 5, wherein, if both said senders match, said traffic control computing unit is structured to assume that said sender of said conflicting traffic control request would have sent a request to cancel said conflicting traffic control request.

7. The traffic control computing device according to claim 2, wherein, when said information acquiring unit has been successful in acquiring a traffic control information object from a traffic control device, said traffic control computing unit is structured to determine that said traffic control device is operating and updates the traffic control information object for the traffic control device stored in said storage device to said traffic control information object newly acquired.

8. The traffic control computing device according to claim 2, adapted so that when said traffic control information object has failed to be acquired from a traffic control device, said traffic control computing unit determines that said traffic control device is not operating and deletes the traffic control information object for the traffic control device determined as being non-operating from said storage device.

9. A traffic control computing device comprising:
a traffic control interface to connect to traffic control devices which control traffic in a network;
a traffic control request interface to connect to traffic control request detecting devices which determine what traffic control must be executed by said traffic control devices;
a traffic control request list containing information objects about traffic control received through the traffic control request interface associated with IDs of the traffic control request detecting devices which sent the information objects;
a list of traffic control request detecting devices containing the IDs and functions of the traffic control request detecting devices connected to said traffic control computing device;
a list of traffic control devices containing the IDs and functions of the traffic control device connected to said traffic control computing device;
a traffic control method list containing the IDs of the connected traffic control devices and control details which are now executed by the traffic control devices; and
a traffic control computing unit which computes control algorithms, based on control requests described in said traffic control request list.

10. A traffic control method comprising:
providing a traffic control computing device connected to traffic control devices which control traffic in a network and traffic control request detecting devices which detect what traffic control must be executed in the network,
receiving a traffic control request;
storing the received traffic control request and the request sender information into a storage device;
determining whether said received traffic control request conflicts with any of control requests previously stored in said storage device; and
if no conflict is found, computing a control algorithm to complete said control request.

11. The traffic control method according to claim 10, further comprising:
if said conflict exists, determining whether said sender of the received request and the sender of the conflicting control request match; and
if both the senders match, deleting said conflicting control request from said storage device.

12. The traffic control method according to claim 10, further comprising:
if said conflict exists, determining whether said sender of the received request and the sender of the conflicting control request match;
if both the senders are different, notifying a network administrator that said conflict exists; and
resolving the conflict by decision made by the network administrator.

13. The traffic control method according to claim 11, further comprising:
determining whether the sender of the received traffic control request is from a pre-registered sender device; and
rejecting the control request from a non-registered sender.

14. The traffic control method according to claim 13, wherein, if said sender of the received traffic control request is a pre-registered sender, said step of determining whether said received traffic control request conflicts with any of control requests previously stored in said storage device is executed.

15. The traffic control method according to claim 12, further comprising:
receiving information as to whether said network administrator has rejected a part or all of either of the conflicting control requests; and
notifying the sender of the rejected control request that the control request was rejected.

16. The traffic control method according to claim 10, further comprising:
comparing said computed control algorithm with control algorithms separately held by the traffic control devices connected to the computing device;
if said computed control algorithm is not held by said traffic control devices, transmitting the computed control algorithm to the appropriate one of said traffic control devices.

17. A network control method comprising:
receiving a traffic control request;
storing the received traffic control request and the request sender information into a storage device;
determining whether said received traffic control request conflicts with any of control requests previously stored in said storage device;
if no conflict is found, computing a control algorithm to complete said control request; and
executing traffic control, according to the computed control algorithm.

18. A control method for a network comprising:
providing traffic control devices which control traffic in the network, traffic control request detecting devices which detect what traffic control must be executed in the network, and a traffic control computing device which processes a traffic control request based on said detected traffic control requirement,
receiving, by said traffic control computing device, information (hereinafter referred to as first information) which comprises the identifiers of said traffic control request detecting devices, the detection functions of the traffic control traffic control request detecting devices, and traffic control requests which are now issued from the traffic control request detecting devices; and
storing the acquired first information into a storage device,
wherein, upon receiving a new traffic control request from one of said traffic control request detecting devices, said traffic control computing device determines whether the newly received traffic control request conflicts with any of the traffic control requests stored in said storage device, if no conflict is found, calculates a control algorithm, based on the received traffic control request, and transmits the calculated control algorithm to the appropriate one of said traffic control devices.

19. The control method for the network according to claim 18, further comprising:
acquiring second information which comprises the identifiers of said traffic control devices and the traffic control functions of the traffic control devices; and
storing said second information acquired into the storage device,
wherein, if the control algorithm calculated by said traffic control computing device has already been held by one of said traffic control devices, said traffic control computing device does not transmit the calculated control algorithm.
